(19) United States
(12) Patent Application Publication
(10) Pub. No.: US 2005/0057555 A1
(43) Pub. Date: Mar. 17, 2005

(54) Information processing apparatus

(75) Inventors: Shingo Nakamura, Hyogo (JP); Hiroshi Kashino, Osaka (JP); Shoji Saibara, Osaka (JP)

Correspondence Address: OSHA & MAY L.L.P., 1221 MCKINNEY STREET, HOUSTON, TX, 77010, US

(73) Assignee: Hitachi Maxell, Ltd., Osaka (JP)

(21) Appl. No.: 10/941,454

(22) Filed: Sep. 15, 2004

(30) Foreign Application Priority Data
Sep. 17, 2003 (JP) 2003-324199
Jan. 21, 2004 (JP) 2004-012550

(51) Int. Cl. G09G 5/00

(52) U.S. Cl. 345/211

(57) ABSTRACT

An information processing apparatus of the present invention includes: a body portion having a control device; a display portion; and a power generation portion of a fuel cell. The display portion is connected to the body portion so that it can be opened or closed, or the body portion includes a lid that can be opened and closed with respect to the display portion. Supply of fuel to a negative electrode of the power generation portion is controlled in connection with an opening/closing operation of the display portion or the lid. With this configuration, the fuel supply can be adjusted depending on the status of use of the display portion so that the fuel can be used efficiently. Accordingly, the apparatus can be operated for a long time. Moreover, since the fuel can be used efficiently, a fuel cartridge may be small, which allows the information processing apparatus to be made thinner and smaller.

### BACKGROUND OF THE INVENTION

1. Field of the Invention

The present invention relates to an information processing apparatus using a fuel cell as a power source.

2. Description of the Related Art

Recently, with the spread of cordless equipment such as a personal computer and a mobile telephone, there is an increasing demand for miniaturization and an increased capacity of a secondary battery that is a power source of the cordless equipment. Currently, a lithium ion secondary battery is being put to practical use as a secondary battery with high energy density that can be reduced in size and weight, and there is an increasing demand for such a lithium ion secondary battery as a portable power source. However, depending upon the kind of cordless equipment to be used, a lithium secondary battery has not ensured a sufficient continuous use time.

In such circumstances, a fuel cell is looked to as a battery satisfying the above-mentioned demand. Among fuel cells, a liquid fuel cell such as a direct methanol type fuel cell using liquid fuel directly for the reaction of a battery can be miniaturized, and thus, it has a potential as a future portable power source.

A fuel cell preferable as a power source of portable equipment such as a notebook personal computer is described, for example, in JP 2002-56855 A. A power generation portion of the fuel cell described in JP 2002-56855 A has a flat shape in which a number of cells are combined in a matrix. Each cell is composed of a positive electrode (air electrode), a negative electrode (fuel electrode), and an electrolyte layer placed between the positive electrode and the negative electrode.

Furthermore, incorporating a power generation portion of a fuel cell into a housing of a display portion of an information processing apparatus such as a notebook personal computer is described, for example, in JP 2002-49440 A.

However, in the information processing apparatus described in JP 2002-49440 A, liquid fuel is supplied to the power generation portion regardless of the operation state of the information processing apparatus. Thus, even when the power supply from the fuel cell may be small (e.g., during a standby period when the display portion is closed to cut off the power supply thereto), liquid fuel still is supplied to the negative electrode, thereby causing waste consumption of the liquid fuel. Moreover, since a fuel cartridge for storing fuel is provided in an upper end part of the display portion, the information processing apparatus cannot be made thinner and smaller.

### SUMMARY OF THE INVENTION

The present invention provides an information processing apparatus including: a body portion having a control device; a display portion; and a power generation portion of a fuel cell. In this information processing apparatus, the display portion is connected to the body portion so that the display portion can be opened and closed, or the body portion includes a lid that can be opened and closed with respect to the display portion. Supply of fuel to a negative electrode of the power generation portion is controlled in connection with an opening/closing operation of the display portion or the lid.

These and other advantages of the present invention will become apparent to those skilled in the art upon reading and understanding the following detailed description with reference to the accompanying figures.

### BRIEF DESCRIPTION OF THE DRAWINGS

FIG. 1 is a perspective view of an information processing apparatus according to Example 1 of the present invention seen from a front side.

FIG. 2 is a perspective view of the information processing apparatus according to Example 1 of the present invention seen from a back side.

FIG. 3 is a cross-sectional view showing main portions of the information processing apparatus according to Example 1 of the present invention in the state where a fuel connection valve provided in a fuel path is open so as to secure the passage of fuel.

FIG. 4 is a cross-sectional view showing main portions of the information processing apparatus according to Example 1 of the present invention in the state where the fuel connection valve provided in the fuel path is closed so as to cut off the passage of fuel.

FIG. 5 is a cross-sectional view showing main portions of the information processing apparatus according to Example 1 of the present invention.

FIG. 6 is a perspective view of an information processing apparatus according to Example 2 of the present invention seen from a back side.

FIG. 7 is a cross-sectional view showing main portions of the information processing apparatus according to Example 2 of the present invention.

FIG. 8 is a cross-sectional view showing main portions of the information processing apparatus according to Example 2 of the present invention in the state where a fuel connection valve provided in a fuel path is open so as to secure the passage of fuel.

FIG. 9 is a cross-sectional view showing main portions of a display portion of an information processing apparatus according to Example 3 of the present invention.

FIG. 10 is a cross-sectional view showing main portions of a fuel supply nozzle of a fuel cartridge of an information processing apparatus according to Example 4 of the present invention to show a configuration of a valve provided inside the fuel supply nozzle.

FIG. 11 is a cross-sectional view showing main portions of an opening of a body portion of the information processing apparatus according to Example 4 of the present invention to show a configuration of a valve provided inside the opening.

FIG. 12 is a cross-sectional view showing main portions of the information processing apparatus according to Example 4 of the present invention at an initial stage in attaching the fuel cartridge into the body portion.

FIG. 13 is a cross-sectional view showing main portions of the information processing apparatus according to Example 4 of the present invention in the state where the valve provided in the body portion is opened at an intermediate stage in attaching the fuel cartridge into the body portion.

FIG. 14 is a cross-sectional view showing main portions of the information processing apparatus according to Example 4 of the present invention in the state where the fuel cartridge is attached to the body portion and the valve provided in the body portion and the valve provided in the fuel cartridge are both opened.

### DETAILED DESCRIPTION OF THE INVENTION

According to the present invention, in an information processing apparatus using a fuel cell as a power source and incorporating a power generation portion of the fuel cell therein, the fuel supply can be adjusted depending on the status of use of the display portion so that the fuel can be used efficiently. This allows the information processing apparatus to be operated for a long time.

Moreover, since the fuel can be used efficiently, a fuel cartridge may be small, which allows the information processing apparatus to be made thinner and smaller.

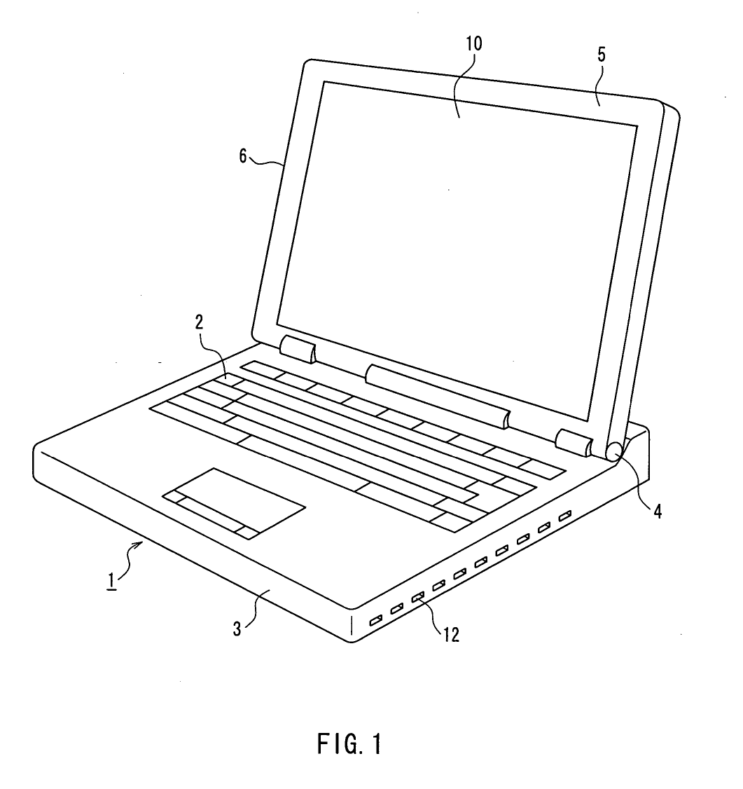

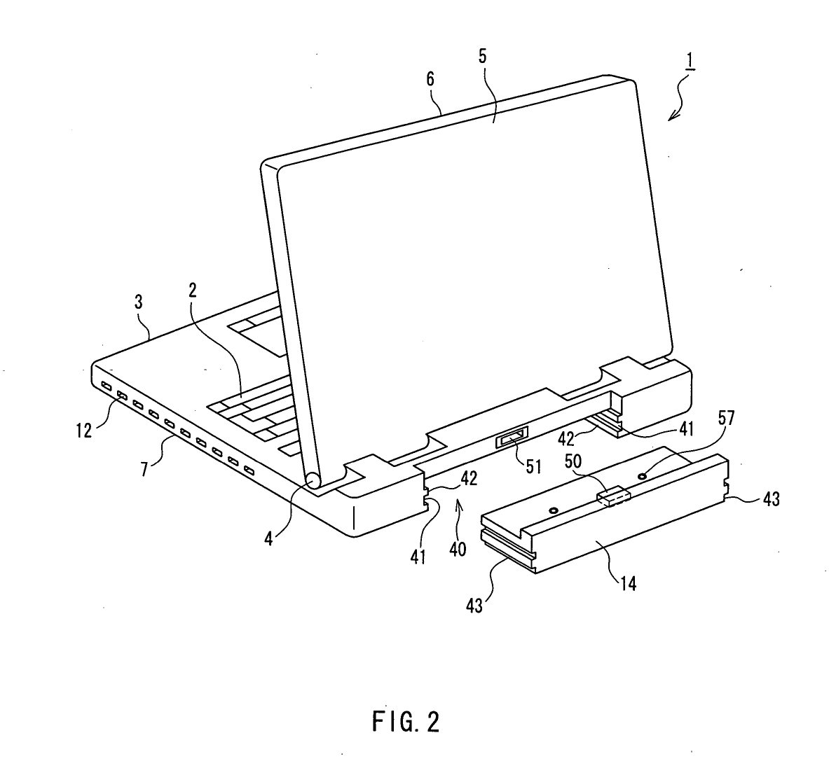

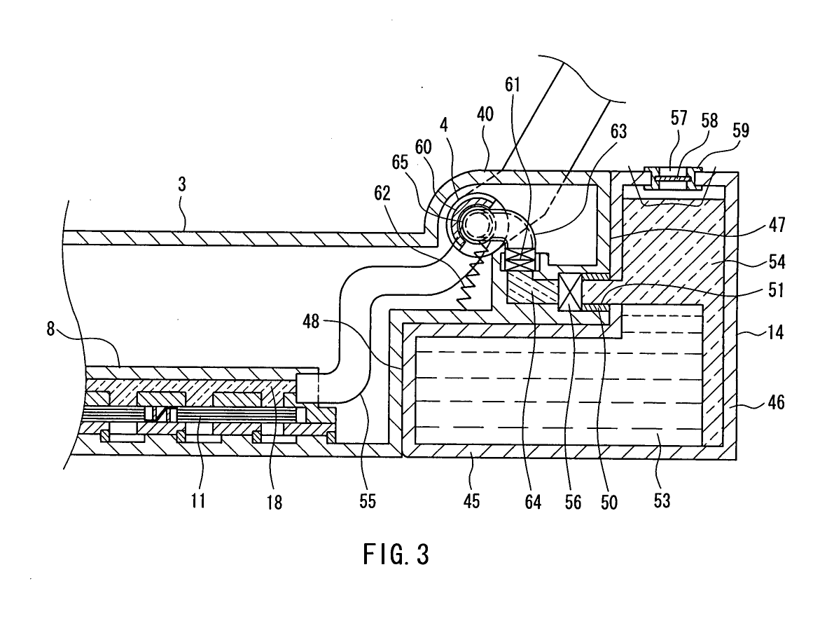

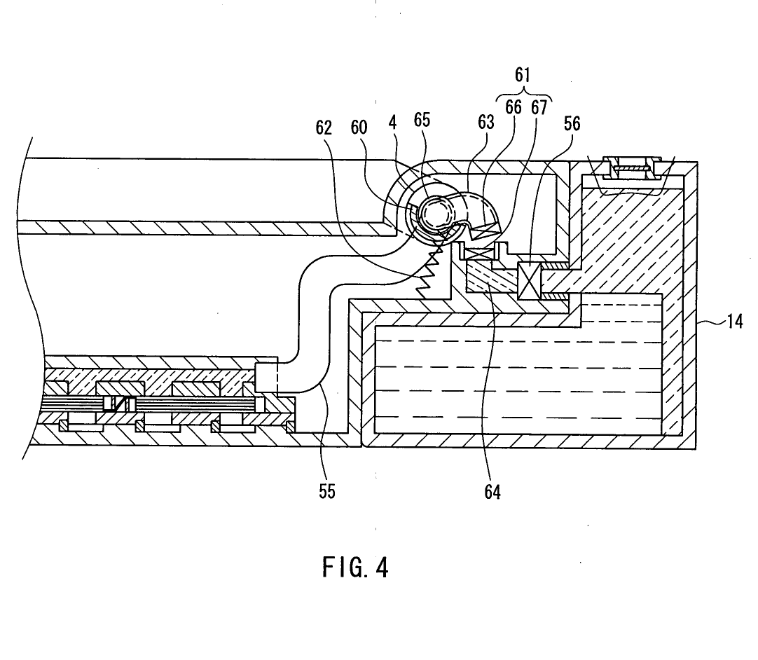

The information processing apparatus of the present invention will be described more specifically with reference to an exemplary information processing apparatus of the present invention shown in FIGS. 1 to 5. As shown in FIGS. 1 and 2, an information processing apparatus according to one embodiment of the present invention includes a body portion 3 having a control device, and a display portion 5 connected to the body portion 3 via a hinge portion 4 so as to be foldable. In a housing 6 of the display portion 5, a display panel 10 is incorporated. In a housing 7 of the body portion 3, a power generation portion 11 of a fuel cell is incorporated as shown in FIG. 3. Furthermore, as shown in FIG. 2, a fuel cartridge 14 is mounted on an attachment portion 40 provided in the body portion 3. More specifically, as shown in FIG. 3, the fuel cartridge 14 has a fuel supply nozzle 50, and when the fuel cartridge 14 is inserted into the attachment portion 40, the fuel supply nozzle 50 is engaged with an opening 51 of the attachment portion 40 with an elastic restoration force so that the fuel cartridge 14 is mounted on the body portion 3 completely. Furthermore, as shown in FIGS. 3 and 4, a fuel path for supplying liquid fuel from the fuel cartridge 14 to negative electrodes 24 of the power generation portion 11 of the fuel cell is provided around the hinge portion 4, and the opening/closing operation of a fuel connection valve 61 provided in the fuel path is controlled in connection with the opening/closing operation of the display portion 5. The fuel path includes: a fuel guiding member 64 for guiding liquid fuel from the fuel cartridge 14 to the fuel connection valve 61; the fuel connection valve 61; a fuel supply member 63; and a fuel guiding member 55 for guiding the liquid fuel from the fuel supply member 63 to the power generation portion 11 of the fuel cell through a hollow portion of the hinge portion 4.

A configuration of an information processing apparatus according to the present invention is by no means limited to the above-described exemplary configuration. For instance, information processing apparatuses having the following configurations also are within the scope of the present invention:
(a) an information processing apparatus in which a power generation portion of a fuel cell and a fuel cartridge are incorporated separately in a display portion and a body portion;
(b) an information processing apparatus in which a power generation portion of a fuel cell and a fuel cartridge are both incorporated in a display portion;
(c) an information processing apparatus that incorporates only a power generation portion of a fuel cell and is supplied with fuel from the outside of the information processing apparatus; and
(d) an information processing apparatus in which a display portion is fixed to a body portion so as to be a part of the body portion, provided with a lid that covers the display portion and can be opened and closed.

In the information processing apparatuses having the above configurations, it is still possible to control the supply of liquid fuel to the negative electrodes of the power generation portion incorporated therein in connection with the opening/closing operation of the display portion or the lid, as in the case of the above-described exemplary information processing apparatus. Accordingly, the present invention also is applicable to the information processing apparatuses having the above configurations.

Furthermore, the information processing apparatus according to the present invention is not limited to an information processing apparatus in which a display portion or a lid covering a display portion is connected to a body portion via a hinge portion. For example, the display portion or the lid covering the display portion may be opened/closed by sliding on the body portion, or the display portion or the lid covering the display portion may be configured so that they can be detached completely from the body portion.

In the following, an example where liquid fuel such as methanol is used as fuel of a fuel cell for the information processing apparatus is described specifically. However, it is to be noted that the present invention also is applicable to the case where gas such as hydrogen gas is used as the fuel.

In the information processing apparatus according to the present invention, an opening/closing operation of the fuel connection valve 61 provided in the fuel path for supplying liquid fuel from the fuel cartridge 14 to the negative electrodes 24 of the power generation portion 11 is controlled, for example, in connection with an opening/closing operation of the display portion 5. Thus, the fuel supply to the negative electrodes 24 of the power generation portion 11 can be cut off when the user of the apparatus carries out a simple operation of closing the display portion 5 after he finishes his task. Accordingly, the user can prevent waste consumption of fuel without paying any particular attention. Thus, for example, when the fuel cartridge 14 is incorporated in the information processing apparatus, it is possible to prolong the life of the fuel cartridge 14. Moreover, by controlling and adjusting the opening amount of the fuel connection valve 61 in the fuel path, the use of the fuel cell can be adjusted efficiently in accordance with the load required by the information processing apparatus. As a result, the amount of fuel to be provided in the information processing apparatus can be reduced so that the enlargement of the fuel cartridge 14 can be minimized, which allows a decrease in thickness and miniaturization of the information processing apparatus to be attained.

Furthermore, in the information processing apparatuses according to the present invention, by limiting the inflow of fuel into the negative electrodes 24 as necessary, instead of cutting off the inflow of the fuel completely, a control device of the body portion 3 can be kept operated during a standby period when the display portion 5 is not used. In this case, it is desirable that the information processing apparatus has a function of limiting the inflow of the fuel into the negative electrodes 24 and a function of cutting off the power supply to the display portion 5. The reason for this is as follows. If the information processing apparatus does not have a function of cutting off the power supply to the display portion 5, power consumed by the information processing apparatus is not reduced even during the standby period, resulting in a shortage of power supplied from the fuel cell. The power supplied to the display portion 5 can be cut off, for example, by turning on/off a switch in connection with opening/closing of the display portion 5.

Hereinafter, examples of the information processing apparatus of the present invention will be described with reference to the accompanying drawings.

### EXAMPLE 1

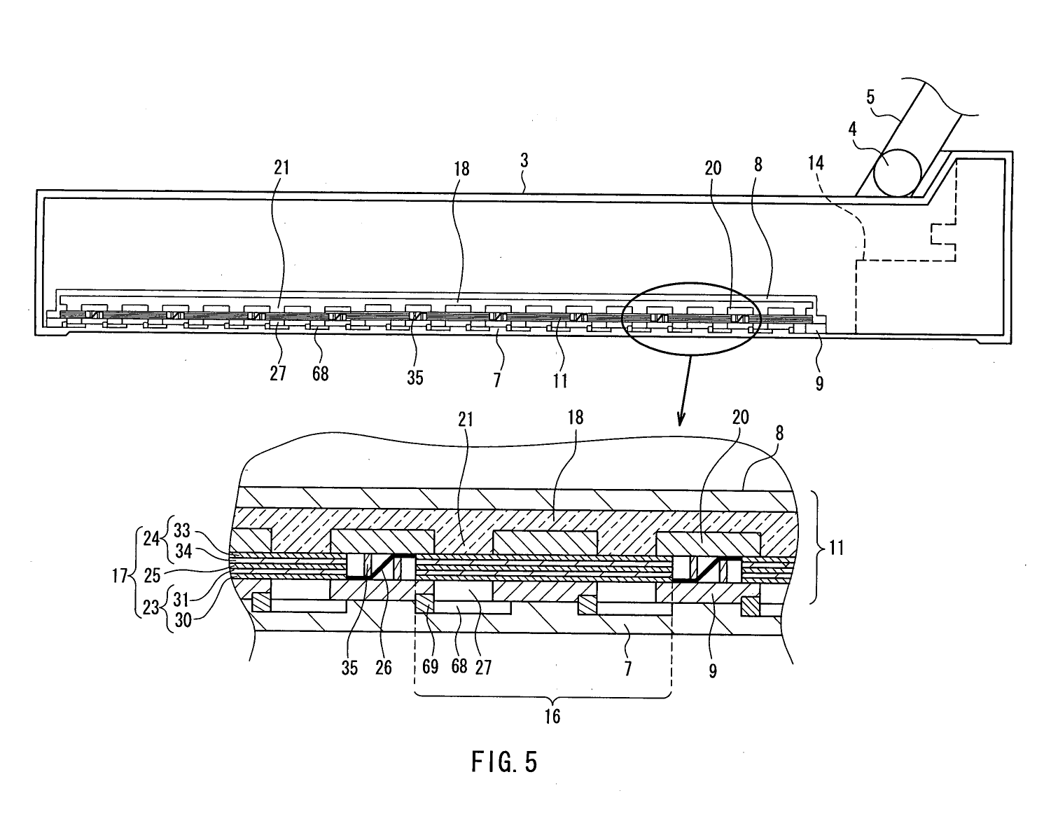

FIGS. 1 to 5 show an exemplary information processing apparatus of the present invention suitable for a notebook personal computer. FIG. 1 is a perspective view of an information processing apparatus of the present example seen from a front side, and FIG. 2 is a perspective view of the same seen from a back side. FIGS. 3 and 4 are cross-sectional views showing main portions of the information processing apparatus of the present example, and they chiefly show a fuel cartridge, an attachment portion for the fuel cartridge, a fuel path for supplying liquid fuel from the fuel cartridge to negative electrodes of a power generation portion, and the like. FIG. 3 shows the state where a fuel connection valve provided in the fuel path is open so as to secure the passage of liquid fuel from the fuel cartridge to the negative electrodes of the power generation portion, while FIG. 4 shows the state where the fuel connection valve is closed so as to cut off the passage of liquid fuel from the fuel cartridge to the negative electrodes of the power generation portion. FIG. 5 is a cross-sectional view showing main portions of chiefly the power generation portion of the information processing apparatus of the present example along with a partially enlarged view thereof.

As shown in FIG. 1, a notebook personal computer (an information processing apparatus) 1 includes: a body portion 3 provided with a control device (such as a central processing unit (CPU) and a memory) and a keyboard 2; and a display portion 5 connected to the body portion 3 at an end on a back side thereof via a hinge portion 4 so as to be foldable. In a housing 6 of the display portion 5, a liquid crystal display panel 10 as an output device is incorporated. Inside the body portion 3, a power generation portion 11 of a fuel cell as a built-in power source of the notebook personal computer 1 is incorporated, as shown in FIG. 5. Although not shown in the drawings, the housing 6 has a configuration in which a back cover in a rectangular plate shape that opens on an upper side and a front cover in a rectangular frame shape are engaged with each other. The front cover and the back cover are made of plastic such as polytetrafluoroethylene (PTFE), rigid polyvinyl chloride, polypropylene, polyethylene, or the like, for example. The front cover and the back cover also may be made of corrosion-resistant metal such as stainless steel. As shown in FIGS. 2 and 3, liquid fuel is supplied to the power generation portion 11 from a fuel cartridge 14 detachably mounted at an end on a back side of the body portion 3 through a fuel path that includes a fuel connection valve 61 provided in the vicinity of the hinge portion 4 connecting the body portion 3 and the display portion 5 in a swingable manner, etc.

As shown in FIG. 5 for example, the power generation portion 11 of the fuel cell includes: a power generation unit 17 in a flat shape composed of a plurality of cells 16; a fuel suction material 18 for supplying fuel to the power generation unit 17; an upper cover 8 provided on the upper surface side in a thickness direction of the body portion 3, for covering the entire upper surface of the fuel suction material 18; a partition wall 20 provided on the bottom surface side in a thickness direction of the body portion 3, for covering the back surface of the fuel suction material 18; and a lower cover 9 for covering the entire lower portion of the power generation unit 17. The partition wall 20 is provided with a number of independent through-holes 21 corresponding to the respective cells 16. The through-holes 21 also are filled with the fuel suction material 18. Also, the lower cover 9 is provided with a number of independent air holes 27 corresponding to the respective cells 16.

The power generation unit 17 has a plurality of cells 16 arranged orderly in a flat shape, and each of the cells includes a positive electrode 23 that reduces oxygen, a negative electrode 24 that oxidizes fuel, and an electrolyte layer 25 placed between the positive electrode 23 and the negative electrode. The power generation unit 17 is attached to the body portion 3 on the bottom surface side in a thickness direction of the body portion 3. The surface size of the power generation unit 17 is set to be substantially the same as an inner surface size of the lower cover 9 provided below the power generation unit 17, and the power generation unit 17 is mounted on the upper surface of the lower cover 9 so as to be in contact therewith.

More specifically, each cell 16 has a rectangular shape (e.g., 80 mm (vertical) and 5 mm (horizontal)). A plurality of cells 16 are arranged in a flat shape in such a manner that the positive electrodes 23 are positioned on the bottom surface side of the body portion 3 in a thickness direction of the body portion 3, and the negative electrodes 24 are positioned on an inner side of the body portion 3 with respect to the positive electrodes 23, and the positive electrode 23 of one of adjacent cells 16 and the negative electrode 24 of the other cell 16 are electrically connected in series through a conductive connection plate 26, whereby the power generation unit 17 is configured. A number of independent air holes 27 are provided in portions of the lower cover 9 that are in contact with the positive electrodes 23. Furthermore, air inflow grooves 68 defined as a concave/convex pattern are formed on the inner bottom surface of the housing 7 of the body portion 3. Oxygen in the air is supplied to the positive electrodes 23 through air holes 12 provided on side surfaces of the housing 7 of the body portion 3. As described above, the power generation unit 17 of the present example is set so as to have substantially the same surface size as the inner surface size of the lower cover 9. Thus, herein, a number of air inflow grooves 68 are formed over the entire inner bottom surface of the housing 7 of the body portion 3.

The positive electrode 23 is configured, for example, by stacking a diffusion layer 30 made of a porous carbon material and a catalyst layer 31 made of carbon powder carrying a catalyst. Examples of the catalyst contained in the catalyst layer 31 include platinum fine particles, and alloy fine particles of platinum and iron, nickel, cobalt, tin, ruthenium or gold. The catalyst layer 31 can contain PTFE resin particles and proton exchange resin particles. As the proton exchange resin particles, particles of polyperfluorosulfonic acid resin, sulfonated polyether sulfonic acid resin, sulfonated polyimide resin, and the like can be used. The surface of the diffusion layer 30 on the catalyst layer 31 side can be coated with a paste of carbon powder containing PTFE resin particles so as to enhance water repellency.

The electrolyte layer 25 is made of a material having no electron conductivity and being capable of transporting protons. An example of the material includes a polyperfluorosulfonic acid resin film. More specifically, “Nafion” produced by Dupont, “Flemion” produced by Asahi Glass Co. Ltd., “Asiplex” produced by Asahi Chemical Industry Co. Ltd., and the like can be used. Other than the above, a sulfonated polyether sulfonic acid resin film, a sulfonated polyimide resin film, a sulfuric acid doped polybenzimidazole film, and the like may be used.

The negative electrode 24 is composed of a diffusion layer 33 and a catalyst layer 34, and has a function of generating protons from fuel (i.e., function of oxidizing fuel). The negative electrode 24 can be configured in the same way as in the positive electrode 23, for example.

The connection plate 26 can be made of noble metal (platinum, gold, etc.), corrosion-resistant metal (stainless steel, etc.), carbon, or the like, for example.

The fuel suction material 18 is, for example, nonwoven fabric made of glass fibers, and is contained in an air gap composed of the upper cover 8 and the partition wall 20. As the fuel suction material 18, another material also can be used as long as its size is not changed largely due to impregnation of fuel, and it is chemically stable.

Furthermore, in order to prevent fuel from flowing to the positive electrodes 23 side or flowing out of the fuel cell, adjacent cells 16 are sealed with an insulator 35. The insulator 35 is made of synthetic rubber such as silicone rubber, fluorine rubber, butyl rubber and urethane rubber, an elastic insulating synthetic resin such as polypropylene, nylon and polyethylene, etc.

As shown in FIG. 2, an attachment portion 40 with a concave formed inward is provided at the center portion of an end on the back side of the body portion 3, and the fuel cartridge 14 is detachably mounted on the attachment portion 40. More specifically, at upper and lower ends of right and left side walls 41, 41 partitioning the attachment portion 40 provided in the body portion 3, flanges 42, 42 that are longer in a front and back direction project so as to be opposed to each other. At corner portions extending in a front and back direction of the right and left wall surfaces of the fuel cartridge 14 confronted to the flanges 42, 42, clearance grooves 43, 43 are cut away. The flanges 42, 42 and the clearance grooves 43, 43 are aligned, and thereafter, the fuel cartridge 14 is inserted in the attachment portion 40, whereby the fuel cartridge 14 is slidably supported along the flanges 42, 42 to be mounted on the body portion 3. Furthermore, by pulling the fuel cartridge 14 to the back side in a reverse procedure, the fuel cartridge 14 can be detached from the body portion 3.

As shown in FIG. 3, the fuel cartridge 14 has an L-shaped cross-section having a long portion 45 extending in a front and back direction, and a short portion 46 extending in a vertical direction. Corresponding thereto, the attachment portion 40 of the body portion 3 has a stepped shape composed of a first receiving surface 47 positioned on a back side and a second receiving surface 48 positioned on a front side of the first receiving surface 47. A fuel supply nozzle 50 made of rubber is formed at the short portion 46 of the fuel cartridge 14 so as to project forward therefrom, and an opening 51 for receiving the nozzle 50 is provided on the first receiving surface 47 of the attachment portion 40. When the fuel cartridge 14 is inserted in the attachment portion 40, the fuel supply nozzle 50 is engaged with the opening 51 with an elastic restoration force as shown in FIG. 3. As a result, the fuel cartridge 14 is mounted on the body portion 3 completely. More specifically, the fuel cartridge 14 in a mounted state can be locked so as not to be slid.

In the mounted state of the fuel cartridge 14 as shown in FIG. 3, upper and lower surfaces of the fuel cartridge 14 are substantially flush with upper and lower surfaces of the notebook personal computer 1 in the state where the display portion 5 is folded to lie over the body portion 3. Furthermore, the back surface of the cartridge 14 also is substantially flush with that of the body portion 3. Thus, the fuel cartridge 14 in a mounted state is not conspicuous, and does not impair the outer appearance of the notebook personal computer 1.

The fuel cartridge 14 includes a fuel tank 53, and a fuel absorbing member 54 placed between the fuel tank 53 and the fuel supply nozzle 50, for example. The fuel absorbing member 54 is made of a porous material such as sponge, and sends the fuel in the fuel tank 53 to the fuel supply nozzle 50 using the capillary action of the fuel absorbing member 54 made of a porous material. Examples of the fuel that is to fill the fuel tank 53 include a methanol aqueous solution, an ethanol aqueous solution, dimethyl ether, a sodium boron hydroxide aqueous solution, a potassium boron hydroxide aqueous solution, a lithium boron hydroxide aqueous solution, and the like. The fuel cartridge 14 is made of, for example, plastic such as PTFE, rigid polyvinyl chloride, polypropylene and polyethylene, or corrosion-resistant metal such as stainless steel.

Between the opening 51 of the attachment portion 40 and the fuel suction material 18 of the power generation portion 11, the fuel guiding member 64 for guiding liquid fuel from the fuel cartridge 14 to the fuel connection valve 61, the fuel connection valve 61, the fuel supply member 63, and the fuel guiding member 55 for guiding the liquid fuel from the fuel supply member 63 to the power generation portion 11 of the fuel cell through a hollow portion of the hinge portion 4 are provided. The fuel guiding member 55 and the crank-shaped fuel supply member 63 are connected to each other by a ring-shaped connection member 65. Furthermore, as shown in FIG. 4, the fuel connection valve 61 is composed of a check valve 66 and a check valve 67 and arranged between the fuel guiding member 64 and the fuel supply member 63. The fuel guiding member 64 and the fuel supply member 63 are connected to each other via this fuel connection valve 61. Owing to the restoration force of a tensile spring 62, the fuel supply member 63 is pressed toward the fuel connection valve 61 at all times. However, when the display portion 5 is closed by the user of the notebook personal computer 1, a C-shaped opening/closing protrusion 60 provided in the hinge portion 4 pushes the fuel supply member 63 upward, thereby bringing the fuel connection valve 61 to a disconnected state, as shown in FIG. 4. On the other hand, when the user opens the display portion 5, the C-shaped opening/closing protrusion 60 provided in the hinge portion 4 is rotated at the same time. As a result, the fuel supply member 63 is pulled down by the restoration force of the tensile spring 62, thereby bringing the fuel connection valve 61 to a connected state, as shown in FIG. 3.

Each of the fuel guiding member 64, the fuel supply member 63 and the fuel guiding member 55 is a fiber flux filling a flexible tube or tubular member, and guides fuel in one direction from the opening 51 to a lower portion of the fuel suction material 18 by the capillary action. The fibers constituting the fuel guiding member 64, the fuel supply member 63 and the fuel guiding member 55 are required to be chemically stable with respect to fuel and be excellent in wettability. Generally, they are made of synthetic fibers such as polyester, nylon, polypropylene, polyurethane, and the like. However, fibers of metal, glass, carbon, and the like also may be used.

In the mounted state of the fuel cartridge 14 as shown in FIG. 3, the fuel absorbing member 54 on the fuel supply nozzle 50 side and the fuel guiding member 64 on the opening 51 side are in contact with each other via a check valve 56 under a predetermined pressure. Thus, a fuel path is formed for supplying liquid fuel from the fuel tank 53 of the fuel cartridge 14 to the negative electrodes 24 of the power generation unit 17 via the fuel absorbing member 54, the fuel guiding member 64, the fuel supply member 63, the fuel guiding member 55, the fuel suction material 18, and the like.

As shown in FIG. 3, through-holes 57 leading to the fuel tank 53 are formed at two portions on an upper surface of the fuel cartridge 14, and a cap member 59 with a gas-liquid separation film 58 is detachably mounted in each through-hole 57. The cap member 59 is made of rubber, and is engaged with the through-hole 57 with an elastic restoration force. The gas-liquid separation film 58 is made of a PTFE sheet having pores, and can release carbon dioxide generated in a discharge reaction from the fuel tank 53 without allowing fuel to leak. It also may be possible that the cap member 59 is removed, and the fuel tank 53 is refilled with fuel through the through-hole 57. That is, the through-hole 57 also functions as a refill port in refilling of fuel. It is to be noted that FIGS. 3 and 4 show the difference between the connected state of the fuel connection valve 61 (where the fuel connection valve 61 is open) (FIG. 3) and the disconnected state of the fuel connection valve 61 (where the fuel connection valve 61 is closed) (FIG. 4) in connection with the opening/closing operation of the display portion 5. In FIG. 4, indication of reference numerals is omitted as to the members not involved in the opening/closing of the fuel connection valve 61. However, it is to be noted that these members in FIG. 4 also are configured in the same way as those in FIG. 3.

In the above-described notebook personal computer 1 of the present example, when the user of the apparatus carries out a simple operation of closing the display portion 5 after he finishes his task, the fuel connection valve 61 can be brought to a disconnected state so that the flow of the fuel from the fuel cartridge 14 into the negative electrodes 24 of the power generation portion 11 is cut off without requiring any particular attention of the user. Thus, waste consumption of fuel can be prevented to prolong the life of the fuel cartridge 14. Moreover, by controlling and adjusting the opening amount of the fuel connection valve 61, the use of the fuel cell can be adjusted efficiently in accordance with the load required by the notebook personal computer 1. Therefore, the amount of fuel to be provided in an information processing apparatus such as a notebook personal computer can be reduced so that the enlargement of the fuel cartridge can be minimized, which allows a decrease in thickness and miniaturization of the information processing apparatus to be attained.

In the present example, as shown in FIG. 5, the positive electrodes 23 are placed so as to be positioned on the bottom surface side of the body portion 3 in a thickness direction of the body portion 3, and the air holes 27 and the air inflow grooves 68 are provided on the bottom surface of the body portion 3. Thus, the air holes 27 and the air inflow grooves 68 can be formed over the entire bottom surface of the body portion 3. As a result, a large surface for introducing air to the positive electrodes 23 can be ensured so that a power generation effective area ratio of the positive electrodes 23 can be increased to enhance the battery performance.

Conventionally, in the body portion of this type of notebook personal computer, an end portion on the back side in the vicinity of the hinge portion is likely to be a dead space. However, when the fuel cartridge 14 is mounted on a portion to be a dead space as in the present example, enlargement of the notebook personal computer 1 by mounting the fuel cartridge 14 is minimized, which allows miniaturization and a decrease in thickness of the notebook personal computer 1 to be attained. Furthermore, since the portion that is used was a dead space, the design of the body portion 3 can be changed with a minimum of effort. In this respect, the present invention can contribute to a reduction in a production cost.

In the present example, the fuel cartridge 14 is detachably mounted on the body portion 3. Therefore, when the fuel is used up, the fuel cartridge 14 can be replaced with a new one immediately. Thus, it is possible to operate the apparatus continuously for a long time without interruption.

Furthermore, in the present example, the fuel path for supplying liquid fuel from the fuel cartridge 14 to the negative electrode 24 of the power generation portion 11 is configured so that it includes the fuel suction material 18, the fuel absorbing member 54, the fuel guiding member 55, the fuel supply member 63 and the fuel guiding member 64 and that the fuel is sucked up by their capillary action. Therefore, the necessity of providing a pump or the like for supplying liquid fuel is eliminated, which contributes to a reduction in power, size and weight of the apparatus. Besides, the fuel in the fuel cartridge 14 can be sucked up completely so that the fuel can be used efficiently. Thus, the present example is advantageous as compared with the fuel supply using a pump, where the liquid sending ability of the pump is decreased remarkably when the amount of the fuel in the fuel cartridge 14 becomes small.

The cell 16 is formed as a unit component including the positive electrode 23, the negative electrode 24, and the electrolyte layer 25. Therefore, the number of components constituting the power generation portion 11 can be reduced. Thus, the assembling process can be simplified, which contributes to a reduction in a production cost of the notebook personal computer 1.

Furthermore, by providing the gas-liquid separation film 58 at the fuel cartridge 14, carbon dioxide and the like generated in a discharge reaction can be released to the atmosphere without allowing liquid fuel in the fuel cartridge 14 to leak.

In the present example, a waste water suction material 69 for draining water generated at the positive electrodes 23 may be provided between the lower cover 9 and the inner bottom surface of the housing 7 of the body portion 3. By forming the waste water suction material 69 so as to extend to the air holes 12, water generated inside the apparatus can be drained to the outside of the apparatus. The waste water suction material 69 is a fiber flux in the form of sponge or cloth, and absorbs water generated at each of the positive electrodes 23 and drain it by its capillary action. The fibers constituting the waste water suction material 69 are required to be chemically stable with respect to fuel and be excellent in wettability. Generally, they are made of synthetic fibers such as polyester, nylon, polypropylene, polyurethane, and the like. However, fibers of metal, glass, carbon, and the like also may be used.

### EXAMPLE 2

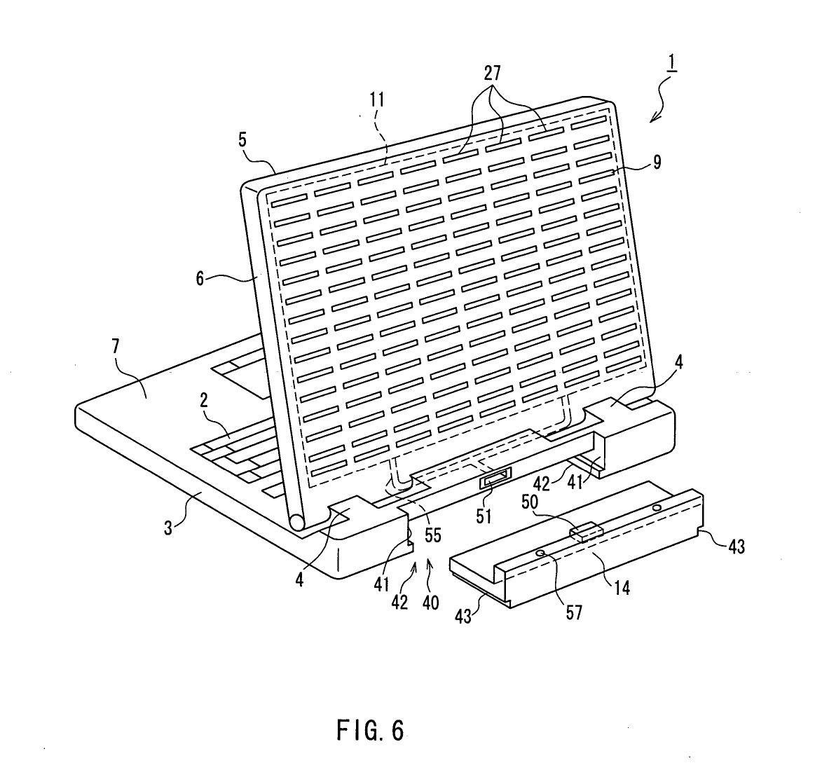

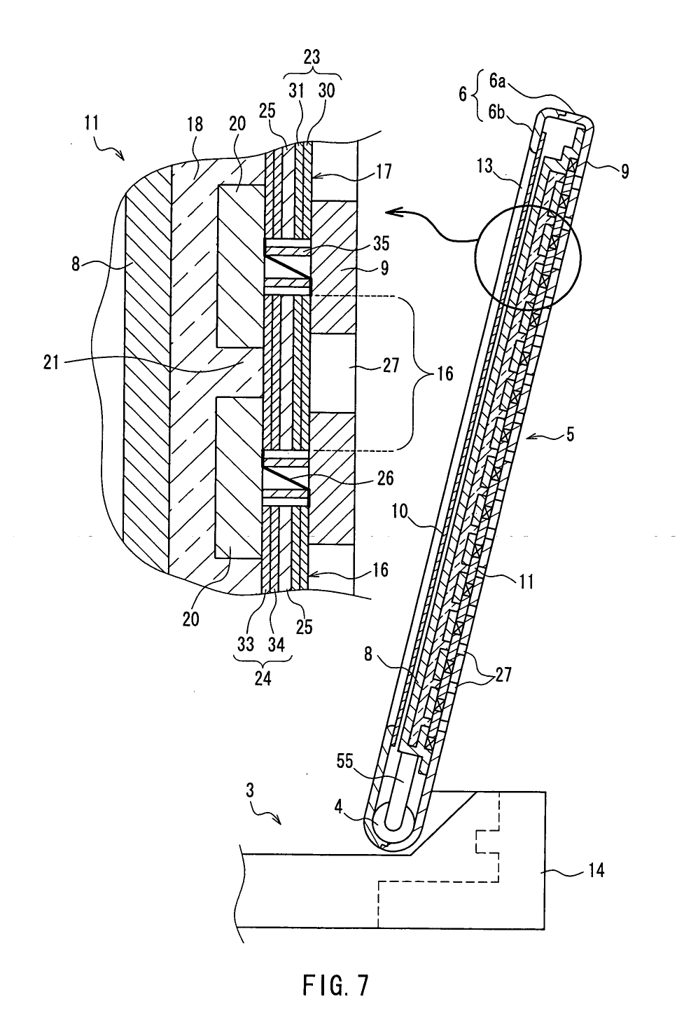

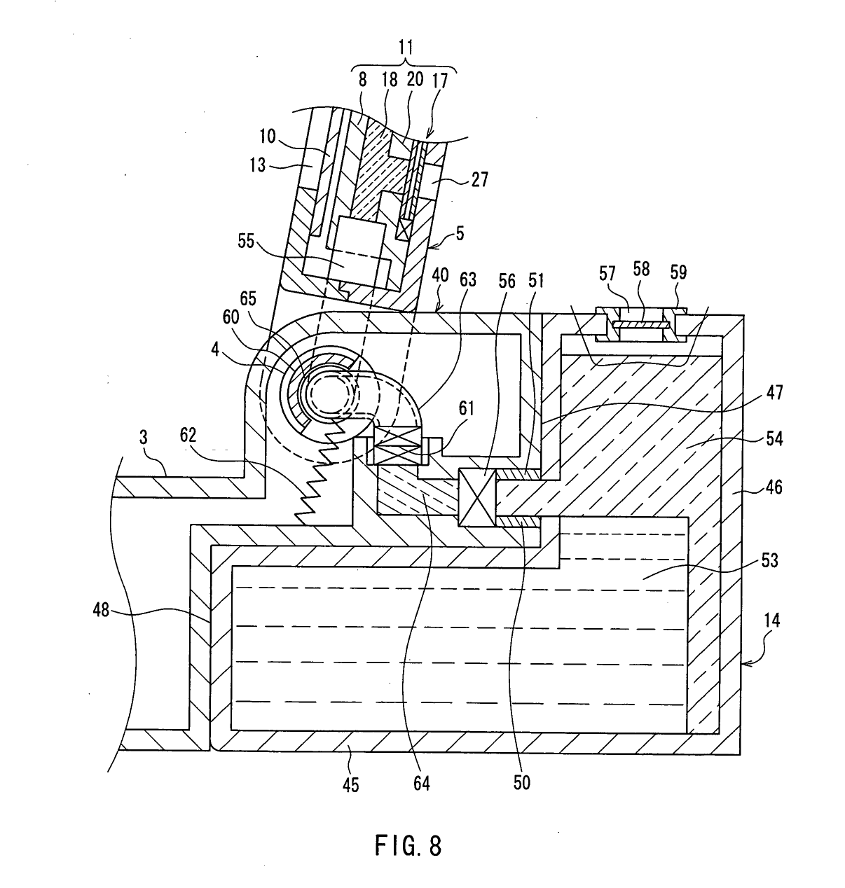

FIGS. 6 to 8 show another exemplary information processing apparatus of the present invention suitable for a notebook personal computer. FIG. 6 is a perspective view of an information processing apparatus of the present example seen from a back side. FIG. 7 shows a cross-sectional view of main portions of chiefly a display portion of the information processing apparatus of the present example along with a partially enlarged view thereof. FIG. 8 is a cross-sectional view showing main portions of the information processing apparatus of the present example, and it chiefly shows a fuel cartridge, an attachment portion for the fuel cartridge, a fuel path for supplying liquid fuel from the fuel cartridge to negative electrodes of a power generation portion, and the like. FIG. 8 shows the state where a fuel connection valve in the fuel path is open so as to secure the passage of liquid fuel from the fuel cartridge to the negative electrodes of the power generation portion.

In FIGS. 6 to 8 regarding the present example, the same components as those in FIGS. 1 to 5 regarding Example 1 are indicated with the same reference numerals.

As shown in FIG. 7, a housing 6 of a display portion 5 has a configuration in which a back cover 6a in a rectangular plate shape that opens on an upper side and a front cover 6b in a rectangular frame shape are engaged with each other. In the housing 6, a liquid crystal display panel 10 as an output device and a power generation portion 11 of a fuel cell as a built-in power source of a notebook personal computer are incorporated. The front cover 6b has a rectangular opening 13 at the center of its front side, and the liquid crystal display panel 10 is defined largely in the opening 13 on the front side. The power generation portion 11, a fuel cartridge 14, a method for supplying liquid fuel to the power generation portion 11, etc. in the present example are basically the same as those in Example 1. In the present example, the back cover 6a also functions as the lower cover 9 of the power generation portion 11.

The power generation unit 17 has a flat plate shape in which the cells 16 including positive electrodes 23 that reduce oxygen, negative electrodes 24 that oxidize fuel, and electrolyte layers 25 placed between the positive electrodes 23 and the negative electrodes 24 are arranged in a matrix. The power generation unit 17 is mounted on the back side of the liquid crystal display panel 10. The surface size of the power generation unit 17 is set to be substantially the same as an inner surface size of the back cover 6a, and the power generation unit 17 is mounted on the inner bottom surface of the back cover 6a so as to be in contact therewith.

A number of independent air holes 27 are provided in portions of the back cover 6a that are in contact with the positive electrodes 23, and oxygen in the air is supplied to the positive electrodes 23 through the air holes 27. In the present example, the air holes 27 can be formed over the entire back surface of the housing 6. Accordingly, a large surface for introducing air to the positive electrodes 23 can be ensured so that a power generation effective area ratio of the positive electrodes 23 can be increased to enhance the battery performance.

### EXAMPLE 3

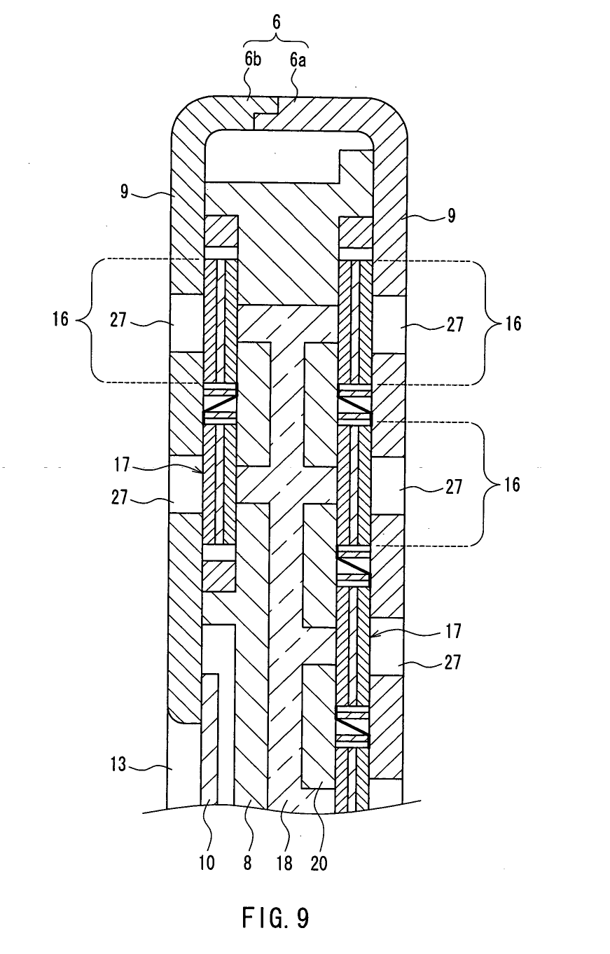

As shown in FIG. 9, an information processing apparatus according to the present example is the same as that in Example 2 except that the power generation unit 17 is provided not only on the back side of the display panel 10 but also on the front side of the display portion 5 where the display panel 10 is defined. According to this configuration, the number of power generation units 17 can be increased to increase the power generated by a fuel cell.

In FIG. 9 regarding the present example, the same components as those in the drawings regarding other examples are indicated with the same reference numerals.

By the way, in electronic equipment incorporating a fuel cell, including an information processing apparatus of the present invention, soiling of the electronic equipment due to leakage of liquid fuel, which occurs, for example, when attaching/detaching a fuel cartridge having a fuel tank to/from the body of the electronic equipment, might be a problem. In addition, since the fuel cartridge may be carried alone, it is necessary to prevent the leakage of liquid fuel also when the fuel cartridge is not attached to the body of the electronic equipment. In order to prevent the above problems, it is desirable that the fuel cartridge 14 is provided with a valve that is closed when the fuel cartridge 14 is not attached to the body portion 3 and is opened when the fuel cartridge 14 is attached to the body portion 3 to allow fuel to be supplied to the body portion 3. Such a valve may be provided inside the fuel supply nozzle 50 of the fuel cartridge 14. For example, a valve that is opened when the body portion 3 presses the valve may be employed.

Furthermore, in order to prevent leakage of liquid fuel from the body portion 3, it is desirable that the body portion 3 is provided with a valve that is opened/closed in connection with the attachment/detachment of the fuel cartridge 14. More specifically, it is desirable that the body portion 3 is provided with a valve that is closed when the fuel cartridge 14 is not attached to the body portion 3 and is opened when the fuel cartridge 14 is attached to the body portion 3 to allow the body portion 3 to receive the fuel supplied from the fuel cartridge 14. The valve of the body portion 3 may be provided in the opening 51 of the body portion 3. For example, a valve that is opened when a component of the fuel cartridge 14 presses the valve may be employed.

The effect of preventing the leakage of liquid fuel can be obtained by providing either one of the valve of the fuel cartridge and the valve of the body portion. However, by providing both of them, the function of preventing the leakage of liquid fuel becomes more reliable to further enhance the reliability of the equipment. In this case, it is desirable that the valve of the fuel cartridge and the valve of the body portion are designed so as to operate in connection with each other, because this allows the body portion to become ready for receiving the fuel with suitable timing in response to the outflow of the fuel from the fuel cartridge.

Furthermore, it is desirable that the pressure at which the valve provided on the liquid fuel receiving side is opened is set to be smaller than or equal to the pressure at which the valve provided on the liquid fuel outflow side is opened. By designing the valve of the body portion so as to be opened simultaneously with or prior to the opening of the valve of the fuel cartridge, the body portion becomes ready for receiving the fuel with the timing no later than the outflow of the fuel from the fuel cartridge. Accordingly, the leakage of the fuel when attaching the fuel cartridge can be suppressed.

Moreover, both the valve of the body portion and the valve of the fuel cartridge preferably are pressed against ring-shaped liquid fuel sealing members (e.g. seal rings) before they are opened. With this configuration, it is possible to prevent liquid fuel from flowing out in the state where the valves are closed. Furthermore, in order to fill a gap between the opening of the body portion and the fuel supply nozzle of the fuel cartridge so as to enhance the sealing property, the fuel supply nozzle of the fuel cartridge preferably is provided with a ring-shaped member (e.g.; a tank seal gasket). The ring-shaped liquid fuel sealing member and the ring-shaped member preferably are made of a material selected from silicone rubber, fluorine rubber, butyl rubber, urethane rubber, polypropylene, nylon, polyethylene, etc. that are excellent in sealing property of liquid fuel.

Furthermore, by providing a protrusion (e.g., a fixing plunger) on an outer surface of the fuel supply nozzle of the fuel cartridge and a recess (e.g., a fixing claw) on an inner surface of the opening of the body portion and engaging the protrusion and the recess with each other, the fuel cartridge can be fixed onto the body portion. Also, the reverse arrangement of the protrusion and the recess also is possible.

In the present invention, the fuel cartridge may be used not only for the storage and supply of liquid fuel but also as a tank for draining waste liquid fuel. The waste liquid fuel can be drained to the outside of the electronic equipment by allowing the waste liquid fuel to flow into the empty fuel cartridge after the fuel has been supplied therefrom or by attaching an additional cartridge provided for receiving waste liquid fuel to the equipment and then allowing the waste liquid fuel to flow into this cartridge.

### EXAMPLE 4

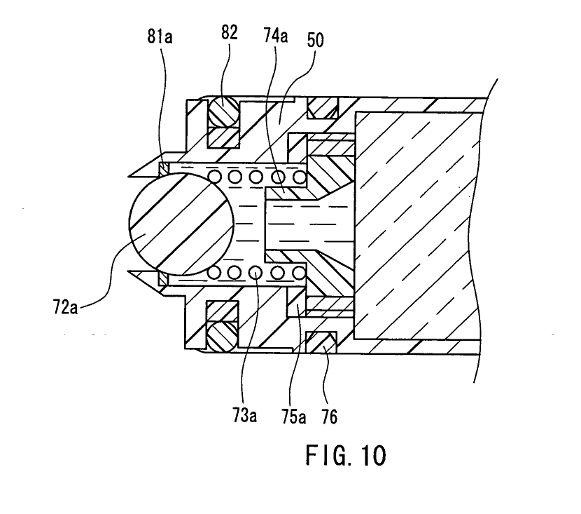

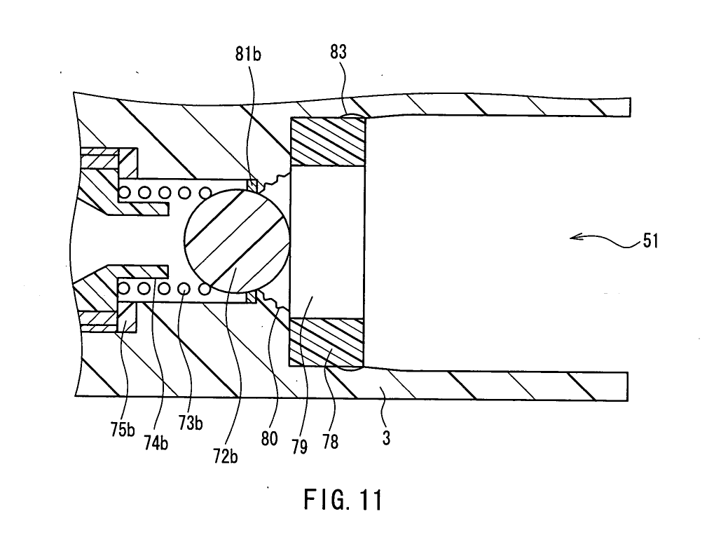

The present example is directed to an example where leakage-preventing performance of a fuel cartridge 14 and a notebook personal computer (an information processing apparatus) 1 is improved by providing a valve 72a that is opened when the fuel cartridge 14 is attached to a body portion 3 inside a fuel supply nozzle 50 as shown in FIG. 10 and providing a valve 72b that is opened/closed in connection with the attachment/detachment of the fuel cartridge 14 inside an opening 51 of the body portion 3 as shown in FIG. 11. Reference numeral 82 in FIG. 10 denotes a fixing projection, and reference numeral 83 in FIG. 11 denotes a fixing recess.

The valve 72b that is spherical and made of resin or metal is provided in the opening 51 of the body portion 3. The valve 72b is pressed against a seal ring 81b by a compression spring 73b. A stopper 74b is provided at a position facing the seal ring 81b, and a stopper gasket 75b is disposed at a lower portion of the stopper 74b. On an inner surface of the opening 51, a ring-shaped slit 80 is formed. Adjacent to the ring-shaped slit 80, a compression absorbing material 78 is provided.

Hereinafter, a method for supplying liquid fuel to a liquid fuel cell will be described.

The fuel cartridge 14 can be inserted in an attachment portion 40 of the body portion 3 in a detachable manner. At the tip of the fuel cartridge 14, a fuel supply nozzle 50 for supplying liquid fuel is provided. The fuel supply nozzle 50 is provided with the valve 72a that is spherical and made of resin or metal, which is pressed against a seal ring 81a by a compression spring 73a. A stopper 74a is provided at a position facing the seal ring 81a, and a stopper gasket 75a is disposed at a lower portion of the stopper 74a.

The compressive force of the compression spring 73b pressing the valve 72b of the body portion 3 is set to be smaller than that of the compression spring 73a pressing the valve 72a of the fuel cartridge 14. Accordingly, when the fuel cartridge 14 is attached to the body portion 3, the valve 72b of the body portion 3 is opened first and then the valve 72a of the fuel cartridge 14 is opened. On the other hand, when the fuel cartridge 14 is detached from the body portion 3, the valve 72a of the fuel cartridge 14 is closed first and then the valve 72b of the body portion 3 is closed.

The contact surface between the valve 72a of the fuel cartridge 14 and the valve 72b of the body portion 3 is located on the inner side with respect to the outer peripheral surface of the body portion 3, and liquid fuel is supplied when the fuel supply nozzle 50 of the fuel cartridge 14 is inserted into the opening 51 of the body portion 3.

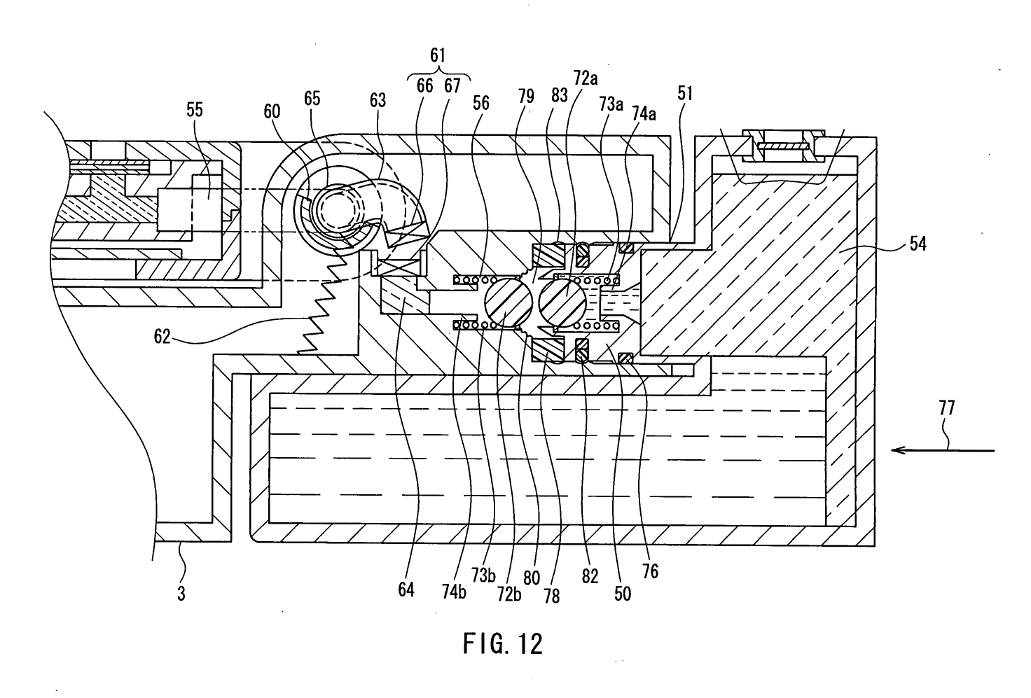

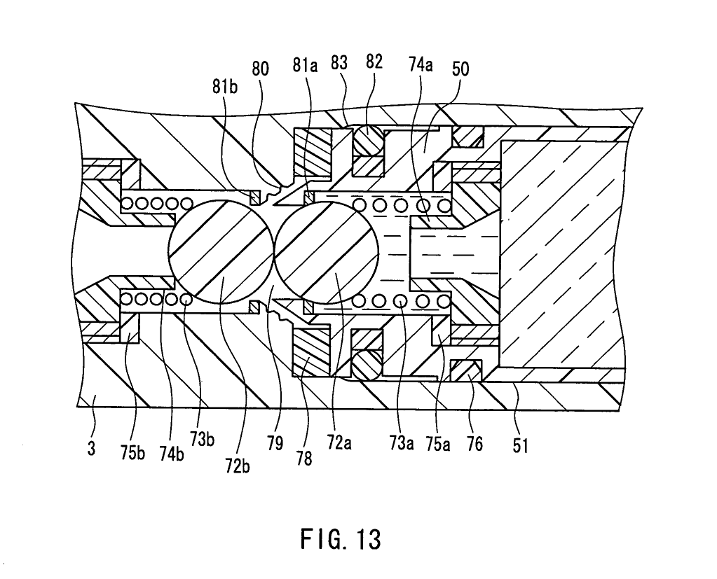

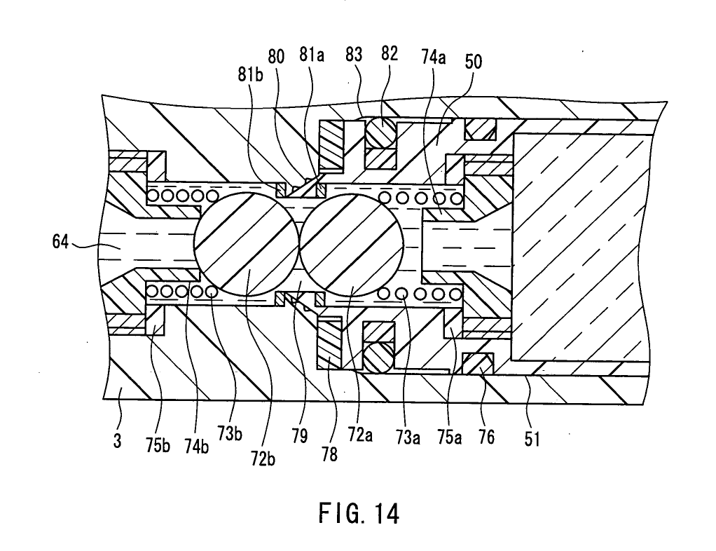

Next, a method for attaching/detaching the fuel cartridge 14 to/from the body portion 3 will be described more specifically. FIGS. 12 to 14 are cross-sectional views showing the state where the fuel cartridge 14 is attached to the body portion 3. FIG. 12 shows an initial stage in inserting the fuel supply nozzle 50 of the fuel cartridge 14 into the opening 51 of the body portion 3, where both the valves 72a and 72b are closed. In FIG. 12, an arrow 77 indicates an insertion direction of the fuel cartridge 14. When the fuel supply nozzle 50 is more deeply inserted into the opening 51, the valve 72a of the fuel cartridge 14 collides with the valve 72b of the body portion 3. When the fuel supply nozzle 50 is still more deeply inserted into the opening 51 of the body portion 3, the valve 72b of the body portion 3 leaves the seal ring 81b to be opened first, as shown in FIG. 13, because the compressive force of the compression spring 73b pressing the valve 72b of the body portion 3 is set to be smaller than that of the compression spring 73a pressing the valve 72a of the fuel cartridge 14. Then, when the fuel supply nozzle 50 is still more deeply inserted into the opening 51, the valve 72b of the body portion 3 comes into contact with the stopper 74b. When the fuel supply nozzle 50 is still more deeply inserted into the opening 51, the valve 72a of the fuel cartridge 14 leaves the seal ring 81a to be opened, as shown in FIG. 14, whereby liquid fuel is supplied to the fuel guiding member 64 of the body portion 3 through the inside of the fuel supply nozzle 50 and an intermediate chamber 79 at the connected portion. The fixing projection 82 engages with the fixing recess 83 at this time, whereby the fuel supply nozzle 50 is fixed to the opening 51.

When the fuel cartridge 14 is pulled out, the above-described processes in inserting the fuel cartridge 14 occur in the reverse order. More specifically, from the state shown in FIG. 14, the valve 72a of the fuel cartridge 14 is closed first and then the valve 72b of the body portion 3 is closed, thus returning to the state shown in FIG. 13.

In the present example, by providing the ring-shaped slit 80, the liquid fuel remaining in the intermediate chamber 79 at the connected portion can be retained so as to prevent the liquid fuel from leaking outside. Preferably, a plurality of ring-shaped slits 80 are provided. Furthermore, although the intended use of the compression absorbing material 78 is to reduce the impact caused when attaching the fuel cartridge 14 to the body portion 3, the compression absorbing material 78 can have the same function as the ring-shaped slit 80. More specifically, by providing the compression absorbing material 78, the liquid fuel remaining in the intermediate chamber 79 can be absorbed by the compression absorbing material 78, whereby the liquid fuel is prevented from leaking outside.

It is to be noted that, in the present invention, the configuration of the power generation portion 11 and the method for incorporating the same to the information processing apparatus, the configuration of the fuel cartridge 14 and the method for attaching the same to the body portion 3, and the like are by no means limited to the above-described examples.

Furthermore, in the present invention, an information processing apparatus is not limited to a notebook personal computer exemplified in Example 1, and includes various kinds of mobile equipment such as a personal digital assistant (PDA) and a mobile telephone. That is, the present invention is applicable to an information processing apparatus requiring a portable power source. Also, a display panel is not limited to a liquid crystal display panel as exemplified herein, and may be an organic electroluminescence (EL) display panel etc., for example. Furthermore, even in an information processing apparatus in which a display portion is a part of a body portion, if the apparatus includes a lid that covers the display portion and can be opened and closed with respect to the display portion, it is possible to control the supply of liquid fuel in connection with the opening/closing operation of the lid in the same manner as in Example 1.

Furthermore, when a power generation portion of a fuel cell and a fuel cartridge are both incorporated in a display portion, or when only a power generation portion of a fuel cell is incorporated in an information processing apparatus and fuel is supplied from the outside of the information processing apparatus, it also is possible to adjust the amount of the fuel used in accordance with the load required by the information processing apparatus.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. An information processing apparatus comprising:
a body portion having a control device;
a display portion; and
a power generation portion of a fuel cell,
wherein the display portion is connected to the body portion so that the display portion can be opened and closed, or the body portion includes a lid that can be opened and closed with respect to the display portion, and
supply of fuel to a negative electrode of the power generation portion is controlled in connection with an opening/closing operation of the display portion or the lid.

2. The information processing apparatus according to claim 1, wherein the fuel is liquid fuel, and the body portion includes an attachable/detachable fuel cartridge for storing the fuel.

3. The information processing apparatus according to claim 2, wherein the fuel cartridge includes a valve that is opened when the fuel cartridge is attached to the body portion.

4. The information processing apparatus according to claim 3, wherein the valve is opened when the body portion presses the valve.

5. The information processing apparatus according to claim 2, wherein the fuel cartridge includes a gas-liquid separation film.

6. The information processing apparatus according to claim 2, wherein the body portion includes a valve that is opened/closed in connection with attachment/detachment of the fuel cartridge.

7. The information processing apparatus according to claim 2, wherein the body portion includes a valve that is opened/closed in connection with attachment/detachment of the fuel cartridge, and the fuel cartridge includes a valve that is opened when the fuel cartridge is attached to the body portion.

8. The information processing apparatus according to claim 7, wherein when the fuel cartridge is attached to the body portion, the valve of the body portion is opened simultaneously with or prior to opening of the valve of the fuel cartridge.

9. The information processing apparatus according to claim 1, further comprising a fuel path for supplying liquid fuel to the negative electrode of the power generation portion,
wherein a fuel connection valve for controlling supply of the liquid fuel in connection with the opening/closing operation of the display portion or the lid is provided in the fuel path.

10. The information processing apparatus according to claim 9, wherein a fuel suction material is provided in the fuel path.

11. The information processing apparatus according to claim 1, wherein the display portion or the lid is connected to the body portion via a hinge portion so as to be foldable.

12. The information processing apparatus according to claim 9, wherein the display portion or the lid is connected to the body portion via a hinge portion so as to be foldable, and the fuel connection valve is provided either inside or around the hinge portion.

13. The information processing apparatus according to claim 1, wherein the power generation portion includes a power generation unit having a plurality of cells arranged in a flat shape, each of the cells including a positive electrode, a negative electrode, and an electrolyte layer.

14. The information processing apparatus according to claim 13, wherein the power generation portion is incorporated in the display portion.

15. The information processing apparatus according to claim 13, wherein the power generation portion is incorporated in the body portion or the lid.

16. The information processing apparatus according to claim 1, further comprising a drain member for draining water generated at a positive electrode from the power generation portion.

17. An information processing apparatus comprising:
a body portion having a control device;
a display portion connected to the body portion; and
a power generation portion of a fuel cell,
wherein the information processing apparatus has an open and closed position, and
supply of fuel to a negative electrode of the power generation portion is controlled in connection with an opening/closing operation of the information processing apparatus.

18. The information processing apparatus according to claim 17, wherein the open and closed position of the information processing apparatus corresponds to an open and closed position of the display portion with respect to the body portion.

19. The information processing apparatus according to claim 17, wherein the open and closed position of the information processing apparatus corresponds to an open and closed position of a lid with respect to the display portion.
